(19) United States
(12) Patent Application Publication
(10) Pub. No.: US 2008/0105626 A1
(43) Pub. Date: May 8, 2008

(54) Fuel filter

(76) Inventors: David Charles Jones, Midlothian, VA (US); Walter H. Stone, Modesto, CA (US)

Correspondence Address: POTTER ANDERSON & CORROON LLP;ATTN: KATHLEEN W. GEIGER, ESQ., P.O. BOX 951, WILMINGTON, DE, 19899-0951, US

(21) Appl. No.: 11/591,733

(22) Filed: Nov. 2, 2006

(51) Int. Cl. B01D 39/00

(52) U.S. Cl. 210/767; 210/505

(57) ABSTRACT

Disclosed herein is an engine fuel filter containing a filter medium of a filtering mass of a nanoweb preferably situated between two scrims. The scrims can be nonwoven webs and the filtering mass is located in an enclosure so as to be crossed by the fuel in its path inside the filter. The nanoweb has a basis weight between about 1.5 gsm and about 40 gsm, and can be in face-to-face and fluid contact with either or both of the upstream and downstream scrims. The nanoweb does not contain glass.

### FIELD OF THE INVENTION

The present invention relates to the filtration of fuel, in particular fuel for diesel engines.

### BACKGROUND

The sophistication of injection equipment in modern engines requires most careful filtration to prevent the impurities present in the fuel from causing damage to, and malfunction of, the delicate injection equipment.

A technical problem which has not been adequately solved in this field is the manufacture of a fuel filter element that can achieve 99+% efficiency in removing particles of 4 microns and higher without the use of any glass media. The use of glass poses a potential threat to critical tolerances in fuel injector systems due to the potential for the discrete-length glass fibers to become separated from the filters and become lodged in the interfaces of the injector moving parts. Existing non-glass media, for example layers of meltblown and wetlaid cellulose, can achieve about 96% efficiency in a pleated filter element.

The present inventors have found a solution to this problem that does not use glass media and yet provides 99% efficiency and above.

### SUMMARY OF THE INVENTION

A first embodiment of the present invention is directed to a filter for engine fuel, comprising a filtering mass which is contained within an enclosure, said enclosure comprising an intake port and a discharge port both in fluid contact with the filtering mass, said filtering mass being located in the enclosure so as to be crossed by the fuel in its path through the enclosure, and wherein said filtering mass comprises an optional first upstream scrim, a polymeric nanoweb of basis weight between about 1.5 g/m² (gsm) and about 40 gsm in face-to-face and fluid contact with the first upstream scrim, and an optional second downstream scrim in face-to-face and fluid contact with the nanoweb on the opposite side of the nanoweb to the optional first upstream scrim, with the proviso that at least one of the upstream scrim or downstream scrim is present, and wherein the nanoweb does not contain glass.

In another embodiment, the present invention is directed to a method for filtering engine fuel comprising feeding fuel through an inlet port of a sealed enclosure, passing the fuel to a first optional coalescing medium, filtering the fuel through a filter mass, passing the fuel to a second optional coalescing medium; and discharging the fuel from the enclosure through an outlet port, wherein the filter mass comprises an optional first upstream scrim, a polymeric nanoweb of basis weight between about 1.5 gsm and about 40 gsm in face-to-face and fluid contact with the first upstream scrim, and an optional second downstream scrim in face-to-face and fluid contact with the nanoweb on the opposite side of the nanoweb to the optional first upstream scrim, with the proviso that at least one of the upstream scrim or downstream scrim is present, and wherein the nanoweb does not contain glass.

### DETAILED DESCRIPTION OF THE INVENTION

### Definitions

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The term “nonwoven” means a web including a multitude of randomly oriented fibers. The fibers can be bonded to each other, or can be unbonded and entangled to impart strength and integrity to the web. The fibers can be staple fibers or continuous fibers, and can comprise a single material or a multitude of materials, either as a combination of different fibers or as a combination of similar fibers each comprised of different materials.

A nonwoven web useful in various embodiments of the invention may comprise fibers of polyethylene, polypropylene, elastomers, polyesters, rayon, cellulose, polyamides, and blends of such fibers. A number of definitions have been proposed for nonwoven fibrous webs. The fibers usually include staple fibers or continuous filaments. As used herein “nonwoven web” is used in its generic sense to define a generally planar structure that is relatively flat, flexible and porous, and is composed of staple fibers or continuous filaments. For a detailed description of nonwovens, see “Nonwoven Fabric Primer and Reference Sampler” by E. A. Vaughn, ASSOCIATION OF THE NONWOVEN FABRICS INDUSTRY, 3d Edition (1992). The nonwovens may be carded, spun bonded, wet laid, air laid, and melt blown as such products are well known in the trade.

Examples of nonwoven webs include webs of meltblown fibers, spunbond fibers, carded webs, air-laid webs, wet-laid webs, spunlaced webs, and composite webs comprising more than one nonwoven layer.

The term “meltblown web” is recognized by those having ordinary skill in the art and as used herein indicates a fibrous web of fibers formed by extruding a molten thermoplastic polymer through a plurality of fine, usually circular, die capillaries as molten threads or filaments, into a high velocity gas stream which attenuates the filaments of molten thermoplastic polymer to reduce their diameter. Exemplary processes for producing melt blown fiber web are disclosed in U.S. Pat. No. 3,849,241 to Butin, et al. and U.S. Pat. No. 4,380,570 to Schwarz. In general, melt blown fibers have an average fiber diameter of from about 2 micrometers up to about 10 micrometers.

The term “spunbond web” is recognized by those having ordinary skill in the art. As used herein it indicates a fibrous web of small diameter filaments that are formed by extruding one or more molten thermoplastic polymers as generally continuous fibers or filaments from a plurality of capillaries of a spinneret, which are cooled while being drawn by an eductor or other well-known drawing mechanism, and then deposited or laid onto a forming surface, in a random manner, to form a loosely entangled, and uniform fiber web. Typically, spunbond fibers have an average diameter of at least about 10 microns. Exemplary processes for producing spunbond nonwoven webs are disclosed, for example, in U.S. Pat. No. 4,340,563 to Appel, et al., U.S. Pat. No. 3,802,817 to Matsuki, et al., U.S. Pat. No. 3,855,046 to Hansen, et al. and U.S. Pat. No. 3,692,618 to Dorschner, et al. Spunbonded webs are characterized by a relatively high strength/weight ratio, high porosity, having abrasion resistance properties, and typically non-uniform in such properties as basis weight and coverage.

The “nanoweb” of the present invention is a nonwoven web constructed of nanofibers. The term “nanofiber” as used herein refers to generally continuous fibers having a diameter or cross-section between about 100 nanometers (nm) and 1000 nm (1 micrometer), preferably between about 200 nm and 800 nm, and more preferably between about 300 nm and about 500 nm. The term diameter as used herein will include the greatest cross-section of non-round shapes.

One technique conventionally used to prepare polymer nanofibers is the electro-spinning process. In the electro-spinning process, a high voltage is applied to a polymer in solution to create nanofibers and nonwoven mats. The polymer solution is loaded into a syringe, and high voltage is applied to the polymer solution within the syringe. Charge builds up on a droplet of solution that is suspended at the tip of the syringe needle. Gradually, as this charge overcomes the surface tension of the solution, this droplet elongates and forms a Taylor cone. Finally, the solution exits out of the tip of the Taylor cone as a jet, which travels through the air to an electrically grounded target medium. While traveling, the solvent evaporates, leaving fibers. The products of this process also have advantages over currently available materials; the fibers are very thin and have a high length to diameter ratio, which provides a very large surface area per unit mass.

While electro-spinning is an advantageous processing method to obtain nanofibers, the production capacity for making nanowebs is extremely limited due to the low throughput of the electro-spinning process. A preferred process for forming the nanowebs of the present invention is the electroblowing process, disclosed in World Patent Publication No. WO 03/080905, corresponding to U.S. patent application Ser. No. 10/477,882, incorporated herein by reference in its entirety.

The electroblowing method comprises feeding a stream of polymeric solution comprising a polymer and a solvent from a storage tank to a series of spinning nozzles within a spinneret, to which a high voltage is applied and through which the polymeric solution is discharged. Meanwhile, compressed air that is optionally heated is issued from air nozzles disposed in the sides of, or at the periphery of, the spinning nozzle. The air is directed generally in the spinning direction as a blowing gas stream which envelopes and forwards the newly issued polymeric solution and aids in the formation of the fibrous web, which is collected on a grounded porous collection belt above a vacuum chamber.

Polymers available for the invention are not restricted to thermoplastic resin, but may utilize most solvent-soluble synthetic resins, including various thermosetting resins. Examples of the available polymers may include polyimide, polyamide, polyaramide, partially aromatic polyamide, polybenzimidazole, polyetherimide, polyacrylonitrile, polyester, polyaniline, polyethylene oxide, styrene butadiene rubber, polystyrene, polyvinyl chloride, polyvinyl alcohol, polyvinylidene chloride, polyvinyl butylene and any copolymer, blend, or derivative of the preceding.

Addition polymers like polyvinylidene fluoride, syndiotactic polystyrene, copolymer of vinylidene fluoride and hexafluoropropylene, polyvinyl alcohol, polyvinyl acetate, amorphous addition polymers, such as poly(acrylonitrile) and its copolymers with acrylic acid and methacrylates, polystyrene, poly(vinyl chloride) and its various copolymers, poly(methyl methacrylate), and its various copolymers, can be solution spun with relative ease because they are soluble at low pressures and temperatures.

### Design of the Filter

The filter comprises an enclosure through which fuel is passed. Any shape or configuration that allows fuel to pass through the filter mass is encompassed by the scope of the claims herein.

The filtering mass is located in the enclosure so as to be crossed by the fuel in its path through the enclosure, and wherein said filtering mass comprises a first upstream scrim, a polymeric nanoweb as defined above of basis weight between about 1.5 gsm and about 40 gsm in face-to-face and fluid contact with the first upstream scrim, and a second downstream scrim in face-to-face and fluid contact with the nanoweb, and wherein the nanoweb does not contain glass.

In a further embodiment of the filter for engine fuel, said polymeric nanoweb has a basis weight of between about 2.5 gsm and about 40 gsm, even between about 3.5 gsm and about 40 gsm, and even between about 4.0 gsm and about 40 gsm. Other ranges of polymeric nanoweb basis weight such as, between about 2.5 gsm and about 37 gsm, about 2.5 gsm and about 34 gsm, about 2.5 gsm and about 31 gsm, about 2.5 gsm and about 28 gsm, about 2.5 gsm and about 25 gsm, about 2.5 gsm and about 22 gsm, about 2.5 gsm and about 19 gsm, about 2.5 gsm and about 16 gsm, about 2.5 gsm and about 13 gsm, about 2.5 gsm and about 10 gsm, about 2.5 gsm and about 7 gsm, and about 2.5 gsm and about 4 gsm, are included in embodiments of the present invention. Also included in the present invention are polymeric nanoweb basis weights such as 3, 3.5, 4, 4.5, 5, 5.5, . . . up to 40 gsm.

The first upstream scrim in the fuel filter can comprise a nonwoven web of basis weight between about 30 gsm and about 200 gsm selected from the group consisting of a spunbond nonwoven web, a carded nonwoven web, a meltblown nonwoven web, paper, and a combination or laminate of the foregoing.

In a further embodiment of the invention, the second downstream scrim further comprises a mass of paper containing predominantly cellulose. In particular, the predominantly cellulose mass preferably comprises a filter paper containing predominantly cellulose having a basis weight of about 50 gsm to about 200 gsm. The predominantly cellulose mass can also be calendared or compressed. The second downstream scrim can comprise a meltblown nonwoven web having a basis weight of about 15 gsm to about 200 gsm. The meltblown nonwoven web is optionally calendared.

In one example of a filter construction, the filter will be configured as a housing in the form of a pot. The upper part of the housing is closed by a cover. The cover has inlet openings for fuel to flow in and an outlet opening through which filtered fuel can be removed. A water discharge valve is preferably provided on a pipe connection at the lower end of the housing. Inside the housing, there is a rising pipe which is provided with openings in the area of the particle filter element.

The filter mass, which is placed over the rising pipe, is comprised of a filter material optionally folded in zigzag pleats, which can also optionally be composed of a plurality of layers. An upstream or downstream element can optionally be present to coalesce any water that may be present in the fuel. The filter mass can also present a flat, curved, or pleated surface to the fuel. The component nanoweb and scrims of the filter mass can be bonded to each other or unbonded. Bonding can be accomplished by any means known to one skilled in the art, for example adhesive, thermal, or ultrasonic bonding.

In a typical operation, the medium to be cleaned, e.g., diesel fuel, flows in through the inlet opening and then flows through the filter mass. Any water in the fuel coalesces to larger collections or droplets, and then flows and collects in an underlying water collecting area or reservoir at the bottom of the filter housing. The fuel to be filtered flows through the filter mass from the outside to the inside and is filtered in the filter mass. Advantageously, the filter mass has a hydrophobic surface to facilitate water separation. Fuel may flow either radially or axially through the filter mass.

If desired, the filter mass can be comprised of multiple layers of a filter medium which exhibit increasing degrees of separation for the particles to be filtered in the direction of fuel flow through the filter. In one embodiment, the filter layer on the incoming flow side is made of synthetic fibers, and the filter layer on the outgoing flow side is made of paper containing predominantly cellulose. In one particularly preferred embodiment, the filter layer on the incoming flow side comprises a meltblown nonwoven web having a basis weight of about 15 gsm to about 300 gsm, and the filter layer on the outgoing flow side comprises an optionally calendared or compressed filter paper containing predominantly cellulose having a basis weight of about 50 gsm to about 200 gsm. In another preferred embodiment, the particle filter may comprise an optionally calendared meltblown nonwoven layer having a basis weight of about 15 gsm to about 300 gsm, between the filter layer on the incoming flow side and the filter layer on the outgoing flow side.

Upon leaving the filter element, the filtered fuel flows through the outlet opening or openings. If water has collected in the water reservoir up to a certain level, it can be removed through the water discharge valve.

### EXAMPLES

For the results in Table 1, the test method used was “Fuel Filter Single Pass Efficiency” per SAE J 1985-93. Fluid was Viscor 4264 (Rock Valley Oil and Chemical Co., Rockford, Ill.). The test conditions were as follows:
Flow Rate: 0.000782 L/min/cm² (1.2 gal/min per 896 in² medium);
Contaminant: ISO Fine Test Dust, 3-20 μm diameter;
Fluid: Viscor 4264;
Temperature: 40° C.
Flat sheet samples were used of a filter mass consisting of (with fluid flowing into the three layered PET meltblown nonwoven):
   Three layered PET meltblown nonwoven/Nanoweb/PET spunbond nonwoven of 70 gsm /PET meltblown nonwoven+Wetlaid Cellulose.

Table 1 summarizes filtration efficiency data for 4 μm particle size.

TABLE 1

| | | Efficiency | Efficiency | |
|---|---|---|---|---|
| Nanoweb basis | Pressure | after 2 | after | Average over |
| weight (gsm) | Drop (kPa) | minutes | 60 minutes | 60 minutes |
| 0 | 1.4 | 96.45% | 62.77% | 75.23% |
| 4 | 2.1 | 99.35% | 97.63% | 98.24% |
| 5 | 2.1 | 99.47% | 98.86% | 99.03% |
| 10 | 2.1 | 99.92% | 99.98% | 99.96% |
| 15 | 2.1 | 99.90% | 99.99% | 99.97% |

In the second set of experiments, the filter-mass layering was identical to the test product used for Table 1 with the following test conditions:
Liquid: CARB diesel fuel was used as the liquid on a pleated filter containing 3896 cm² of filter media;
Flow Rate: 0.0011653 L/min/cm²;
Contaminant: ISO 12103-1 A3 medium test dust, 1-120 μm diameter.

Table 2 summarizes filtration efficiency data for 4 μm particle size.

TABLE 2

| Nanoweb basis | Pressure | Average over |
|---|---|---|
| weight (gsm) | Drop (kPa) | 60 minutes |
| 4 | 25.5 | 99.80% |
| 5 | 25.5 | 99.90% |
| 10 | 25.5 | 100.00% |

The superiority of the claimed filter both initially and over time is clearly demonstrated by these data.

We claim:

1. A filter for engine fuel, comprising a filtering mass which is contained within an enclosure, said enclosure comprising an intake port and a discharge port both in fluid contact with the filtering mass, said filtering mass being located in the enclosure so as to be crossed by the fuel in its path through the enclosure, and wherein said filtering mass comprises an optional first upstream scrim, a polymeric nanoweb of basis weight between about 1.5 gsm and about 40 gsm in face-to-face and fluid contact with the first upstream scrim, and an optional second downstream scrim in face-to-face and fluid contact with the nanoweb on the opposite side of the nanoweb to the optional first upstream scrim, with the proviso that at least one of the upstream scrim or downstream scrim is present, and wherein the nanoweb does not contain glass.

2. The filter for engine fuel of claim 1, wherein said polymeric nanoweb has a basis weight of between about 2.5 gsm and about 40 gsm.

3. The filter for engine fuel of claim 1, wherein said polymeric nanoweb comprises nanofibers of a polymer selected from the group consisting of a polyimide, an aliphatic polyamide, an aromatic polyamide, a partially aromatic polyamide, polysulfone, cellulose acetate, polyether sulfone, polyurethane, poly(urea urethane), polybenzimidazole, polyetherimide, polyacrylonitrile, poly(ethylene terephthalate), polyaniline, poly(ethylene oxide), poly(ethylene naphthalate), poly(butylene terephthalate), polystyrene, poly(vinyl chloride), poly(vinyl alcohol), poly(vinylidene fluoride), poly(vinyl butylene), copolymers of polyvinylidene fluoride, syndiotactic polystyrene, copolymer of vinylidene fluoride and hexafluoropropylene, polyvinyl alcohol, polyvinyl acetate, copolymers of poly(acrylonitrile) with acrylic acid, copolymers of poly(acrylonitrile) with methacrylates, polystyrene, poly(vinyl chloride), poly(methyl methacrylate), and any blends, copolymers or derivative compounds of the preceding.

4. The filter for engine fuel of claim 1, wherein said polymeric nanoweb comprises fibers of average diameter between about 100 and about 1,000 nm.

5. The filter for engine fuel of claim 1, wherein said polymeric nanoweb comprises fibers of average diameter between about 200 and about 800 nm.

6. The filter for engine fuel of claim 1, wherein said polymeric nanoweb comprises fibers of average diameter between about 300 and about 500 nm.

7. The filter for engine fuel of claim 1, wherein said first upstream scrim comprises a nonwoven web of basis weight between about 30 gsm and about 200 gsm, said nonwoven web being selected form the group consisting of a spunbond nonwoven web, a carded nonwoven web, a meltblown nonwoven web, paper, a combination of the foregoing, and a laminate of the foregoing.

8. The filter for engine fuel of claim 1, wherein said enclosure is cylindrical and the filtering mass is located coaxially with the circumference of the curved surface of the enclosure and is optionally pleated.

9. The filter for engine fuel of claim 1, wherein said enclosure further comprises a water collection chamber.

10. The filter for engine fuel of claim 1, wherein the filtration mass is comprised of multiple layers of a filter medium, which layers exhibit an increasing degree of separation for the particles to be filtered out in the direction of flow.

11. The filter for engine fuel of claim 1, wherein the second downstream scrim further comprises a nonwoven mass located on the downstream side of the filtration mass.

12. The filter for engine fuel of claim 11, wherein the nonwoven mass comprises a filter paper comprising cellulose having a basis weight of about 50 gsm to about 300 gsm.

13. The filter for engine fuel of claim 12, wherein the paper mass is calendared or compressed.

14. The filter for engine fuel of claim 1, wherein the second downstream scrim comprises a meltblown nonwoven web having a basis weight between about 15 gsm and about 200 gsm.

15. The filter for engine fuel of claim 14, wherein the meltblown nonwoven web is calendared.

16. A method for filtering engine fuel comprising:
feeding fuel through an inlet port of a sealed enclosure;
passing the fuel to a first optional coalescing medium;
filtering the fuel through a filter mass;
passing the fuel to a second optional coalescing medium; and
discharging the fuel from the enclosure through an outlet port,
wherein the filter mass comprises an optional first upstream scrim, a polymeric nanoweb of basis weight between about 1.5 gsm and about 40 gsm in face-to-face and fluid contact with the first upstream scrim, and an optional second downstream scrim in face-to-face and fluid contact with the nanoweb on the opposite side of the nanoweb to the optional first upstream scrim, with the proviso that at least one of the upstream scrim or downstream scrim is present, and wherein the nanoweb does not contain glass.

17. The method of claim 16, wherein said polymeric nanoweb has a basis weight of between about 2.5 gsm and about 40 gsm and comprises nanofibers of average diameter between about 100 and about 1,000 nm.

18. The method of claim 16, wherein said polymeric nanoweb comprises nanofibers of a polymer selected from the group consisting of a polyimide, an aliphatic polyamide, an aromatic polyamide, partially aromatic polyamide, polysulfone, cellulose acetate, polyether sulfone, polyurethane, poly(urea urethane), polybenzimidazole, polyetherimide, polyacrylonitrile, poly(ethylene terephthalate), polyaniline, poly(ethylene oxide), poly(ethylene naphthalate), poly(butylene terephthalate), polystyrene, poly(vinyl chloride), poly(vinyl alcohol), poly(vinylidene fluoride), poly(vinyl butylene), copolymers of polyvinylidene fluoride, syndiotactic polystyrene, copolymer of vinylidene fluoride and hexafluoropropylene, polyvinyl alcohol, polyvinyl acetate, copolymers of poly(acrylonitrile) with acrylic acid, copolymers of poly(acrylonitrile) with methacrylates, polystyrene, poly(vinyl chloride), poly(methyl methacrylate), and any blends, copolymers or derivative compounds of the preceding.

19. The method of claim 16, wherein said first upstream scrim comprises a nonwoven of basis weight between about 30 gsm and about 200 gsm, said nonwoven web being selected from the group consisting of a spunbond nonwoven web, a carded nonwoven web, a meltblown nonwoven web, paper, a combination of the foregoing, and a laminate of the foregoing.

20. The method of claim 16, wherein the second downstream scrim further comprises a paper mass containing predominantly cellulose located downstream of the filtration mass.

21. The method of claim 16, wherein the second downstream scrim comprises a meltblown nonwoven web having a basis weight between about 15 gsm and about 200 gsm.

22. The method of claim 16, wherein particles of 4 micrometers and above are filtered out of said engine fuel with an efficiency of at least about 99%.
